(19) United States
(12) Patent Application Publication
(10) Pub. No.: US 2018/0220595 A1
(43) Pub. Date: Aug. 9, 2018

(54) VERTICAL PLANT GROWING SYSTEM

(71) Applicant: Trenton L. HANCOCK, Creswell, OR (US)

(72) Inventor: Trenton L. HANCOCK, Creswell, OR (US)

(21) Appl. No.: 15/890,111

(22) Filed: Feb. 6, 2018

Related U.S. Application Data
(60) Provisional application No. 62/455,286, filed on Feb. 6, 2017.

(51) Int. Cl. A01G 9/24; A01G 7/04; A01G 9/02; A01G 9/20

(52) U.S. Cl. CPC A01G 9/24; A01G 9/20; A01G 9/023; A01G 7/045

(57) ABSTRACT

A vertical plant growing system may include a vertical plant stand having a central lighting array and defining a plurality of guided airflows, the plant stand being coupled to a heating, ventilation, and air conditioning (HVAC) system. The HVAC system and plant stand may be operable in a plurality of airflow modes, ranging from about 35 degrees Fahrenheit (to inhibit insect growth) to about 98 degrees Fahrenheit (to kill mold). Accordingly, systems and methods of the present disclosure may facilitate or enhance organic growing methods, e.g., for flowering plants.

### CROSS-REFERENCES

This application claims the benefit under 35 U.S.C. § 119(e) of the priority of U.S. Provisional Patent Application Ser. No. 62/455,286, filed Feb. 6, 2017, the entirety of which is hereby incorporated by reference for all purposes.

### FIELD

This disclosure relates to systems and methods for growing and cultivating plants. More specifically, the disclosed embodiments relate to vertical plant growing systems that reduce or eliminate the need for insecticides and mold-inhibiting chemicals.

### SUMMARY

The present disclosure provides systems, apparatuses, and methods relating to vertical growing systems for plants. Systems and methods disclosed herein may have multiple air flow and temperature modes configured to control undesirable fungi and/or insects, thereby greatly reducing or eliminating the need for chemical treatments.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative vertical plant growing system in accordance with aspects of the present disclosure

FIG. 2 is a schematic overview of an illustrative vertical plant growing system that is an embodiment of the system of FIG. 1.

FIG. 3 is a schematic sectional side view of a vertical plant growing tower suitable for use in the system of FIG. 2.

FIG. 4 is an isometric view of an illustrative embodiment of the vertical plant growing tower of FIG. 3.

FIG. 5 is an isometric view of a portion of a leg of the tower of FIG. 4.

FIG. 6 is an isometric view of an upper manifold of a central column portion of the tower of FIG. 4.

FIG. 7 is an isometric view of the upper manifold of the central column portion, from a lower viewpoint.

FIG. 8 is a side elevation view of the central column portion and light tube of the tower of FIG. 4.

FIG. 9 is a side elevation view of one light module of the light tube of FIG. 8.

FIG. 10 shows the vertical plant growing system of FIG. 2 in a first configuration or mode.

FIG. 11 shows the vertical plant growing tower of FIG. 3 in the first configuration or mode.

FIG. 12 shows the vertical plant growing system of FIG. 2 in a second configuration or mode.

FIG. 13 shows the vertical plant growing tower of FIG. 3 in the second configuration or mode.

FIG. 14 shows the vertical plant growing system of FIG. 2 in a third configuration or mode.

FIG. 15 shows the vertical plant growing tower of FIG. 3 in the third configuration or mode.

FIG. 16 is a schematic diagram of a control system suitable for use in a vertical plant growing system according to the present teachings.

FIG. 17 is a schematic diagram of an illustrative data processing system suitable for use in the control system of a vertical plant growing system as described herein.

FIG. 18 is a schematic diagram of a PLC system suitable for use in an illustrative control system.

FIG. 19 is a schematic diagram of a distributed data processing system (or network) suitable for use with a vertical plant growing system as described herein.

### DETAILED DESCRIPTION

Various aspects and examples of a vertical plant growing system having improved mold and insect control, as well as related methods, are described below and illustrated in the associated drawings. Unless otherwise specified, a plant growing system according to the present disclosure, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A through I, each of which is labeled accordingly.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

The terms “inboard,” “outboard,” “upper,” and “lower” (and the like) are intended to be understood in the context of a vertical tower for plant growing described herein, as installed in a vertical orientation. For example, “outboard” may indicate a relative position that is laterally or radially farther from the centerline of the tower, or a direction that is away from the tower's longitudinal axis. Conversely, “inboard” may indicate a direction toward the axis, or a relative position that is closer to the axis. Similarly, “top” or “upper” means toward the top portion of the tower, and “bottom” or “lower” means toward the bottom portion of the tower (or the floor/support surface).

“Coupled” means connected, either permanently or releasably, whether directly or indirectly through intervening components, and is not necessarily limited to physical connection(s).

### Overview

In general, a vertical plant growing system in accordance with the present teachings may include a forced-air heating, ventilation, and air conditioning (HVAC) system coupled to one or more vertical growing towers, each of which is configured to house several plants. The HVAC system may include dehumidification functionality. The system is configured to efficiently utilize floor space while controlling harmful insects and mold growth using (predominantly or exclusively) air temperature control combined with enhanced air flow around and over the plants. In one mode, heat from the lights used to promote plant growth is recycled using the HVAC system, and mixed with lower temperature air, as needed. This heated air can temporarily be raised to a temperature sufficient to inhibit or kill typical molds found on the plants being grown (e.g., flowering plants, such as tomato plants, grapevines, avocados, peppers, and/or the like). In another mode, the lights are off, and air is recirculated. The air can be cooled temporarily and periodically to a very low temperature and used to inhibit the growth of insects (or the like), or to exterminate certain insects. Each of the growing towers may have a plurality of selectable air flow pathways, with different pathways selected (e.g., automatically) based on the mode of the HVAC system. A controller or control system may be used to operate the HVAC system, based on inputs from various sensors and on programmed algorithmic responses, as well as manual settings and/or intervention.

Aspects of the control system may be embodied as a computer method, computer system, or computer program product. Accordingly, aspects of the control system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the control system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the control system may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the control system are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s). In some examples, machine-readable instructions may be programmed onto a programmable logic device, such as a field programmable gate array (FPGA).

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block(s).

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the control system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of exemplary plant growing systems, as well as related systems and/or methods. The examples in these sections are intended for illustration and should not be interpreted as limiting the entire scope of the present disclosure. Each section may include one or more distinct embodiments or examples, and/or contextual or related information, function, and/or structure.

### A. Illustrative Plant Growing System—General

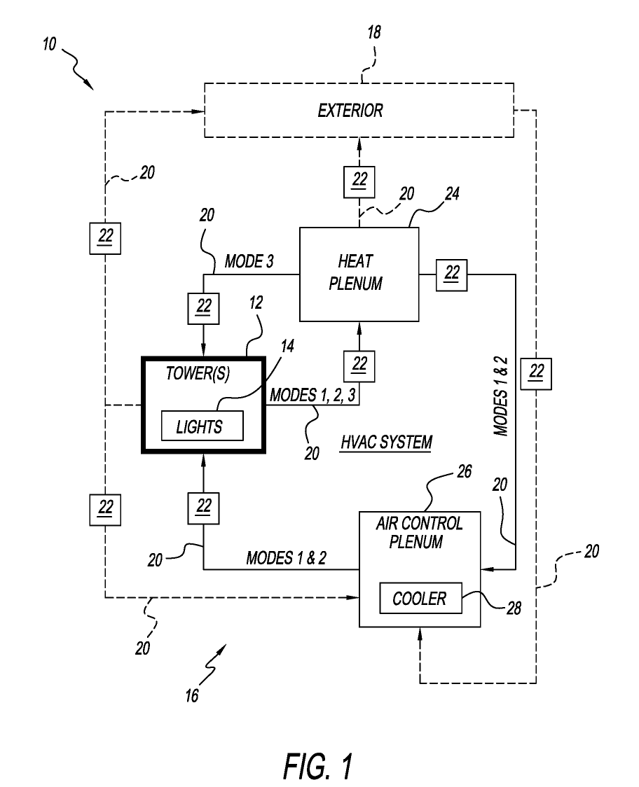

As shown in FIG. 1, this section describes a vertical growing system 10 that is an example of the system described generally in the Overview above.

System 10 includes one or more towers 12 configured to support plants on one or more walls of shelves, each tower having a central column of grow lights 14. For example, plants may be supported on shelves, either in pots or in portions of the shelves themselves. Each of the towers may include structures and mechanisms configured to direct air over and through the plants, e.g., for purposes of temperature control.

Air flows to and from the tower(s), and therefore to and from the plants, are controlled by a heating, ventilation, and air conditioning (HVAC) system 16. In general, towers 12 are housed in one or more enclosures (e.g., a building or similar structure). HVAC system 16 is also housed in an enclosure, which may include the same and/or a different enclosure as the towers. Accordingly, air may be exchanged between the towers, the HVAC system, and an exterior 18 (e.g., the ambient environmental atmosphere outside the enclosure(s)).

As depicted in FIG. 1, air pathways 20 are established between different portions of HVAC system 16, towers 12, and exterior 18. These pathways may include any structure configured to transport air, such as one or more ducts, pneumatic lines, pipes, tubes, etc. Flows through each pathway may be controlled via control devices 22, which may include any suitable device or devices configured to promote or inhibit air flow. For example, control devices 22 may include one or more fans, dampers, valves, flaps, blowers, compressors, and/or the like, or any combination of these.

HVAC system 16 may also include one or more plenum spaces (AKA plenums, spaces, cavities, rooms, and/or chambers) configured to aid in the air-handling process, such as a heat plenum 24 and an air control plenum 26. In this example, air control plenum 26 has an associated cooler 28, which may include any suitable air cooling or refrigeration device configured to reduce the temperature of air in the space.

System 10 may be transitionable between multiple modes or configurations, e.g., by reconfiguring control devices 22 in one or more of the air pathways. For example, a first mode may include creating a loop from air control plenum 26, to towers 12, to heat plenum 24, and returning to the air control plenum. In this first mode, lights 14 are energized. Heat generated by the lights causes the air temperature to increase. To counteract this effect, the air temperature is managed to be within a “normal” range (for the plants) by cycling cooler 28 and/or letting in cooler air from exterior 18. In another example, a second mode may again include a loop from air control plenum 26, to towers 12, to heat plenum 24, and returning to the air control plenum. This loop may include the same or other air ducts and the like, as compared with the loop of the first mode. In the second mode, lights 14 are deenergized, such that heat is no longer being supplied to the airflow. Accordingly, the air can be cooled more significantly, e.g., to near freezing temperatures, using cooler 28 and/or exterior air. These low temperatures may be controlled and utilized to provide prolonged refrigeration of the plants, resulting in the control of many harmful insects.

In another example, a third mode may include a closed loop between towers 12 and heat plenum 24. Recirculating air in this loop, with lights 14 on in the tower(s) and/or a furnace energized in the heat plenum, will result in a significant rise in air temperature. This higher temperature may be controlled and utilized to provide a short burst of heat to the plants, which may be useful for killing or controlling the growth of certain undesired molds (or the like).

### B. Illustrative HVAC System and Vertical Plant Growing Tower

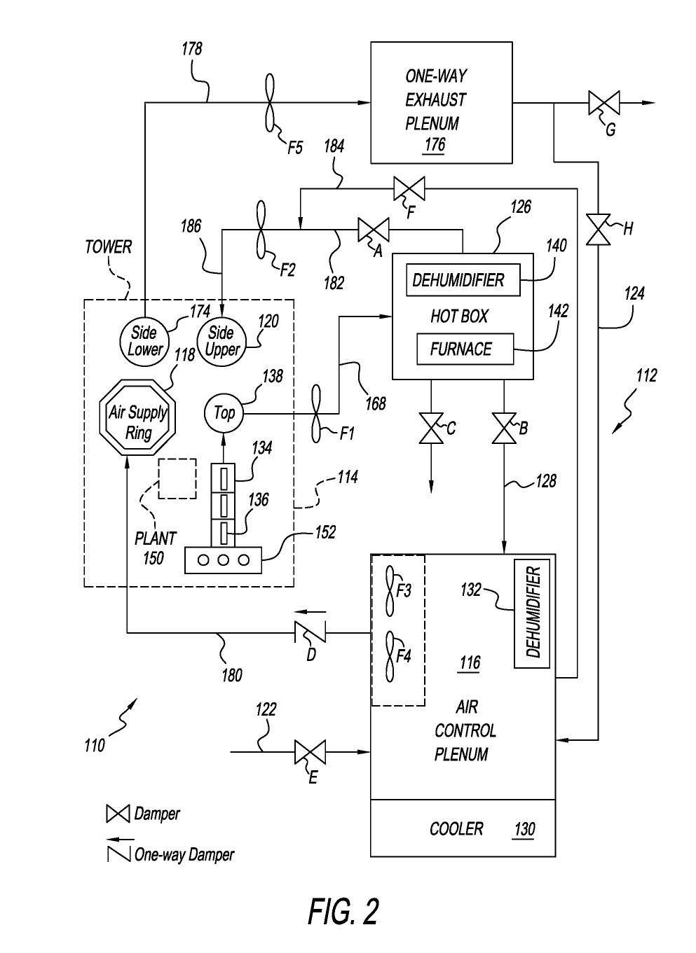

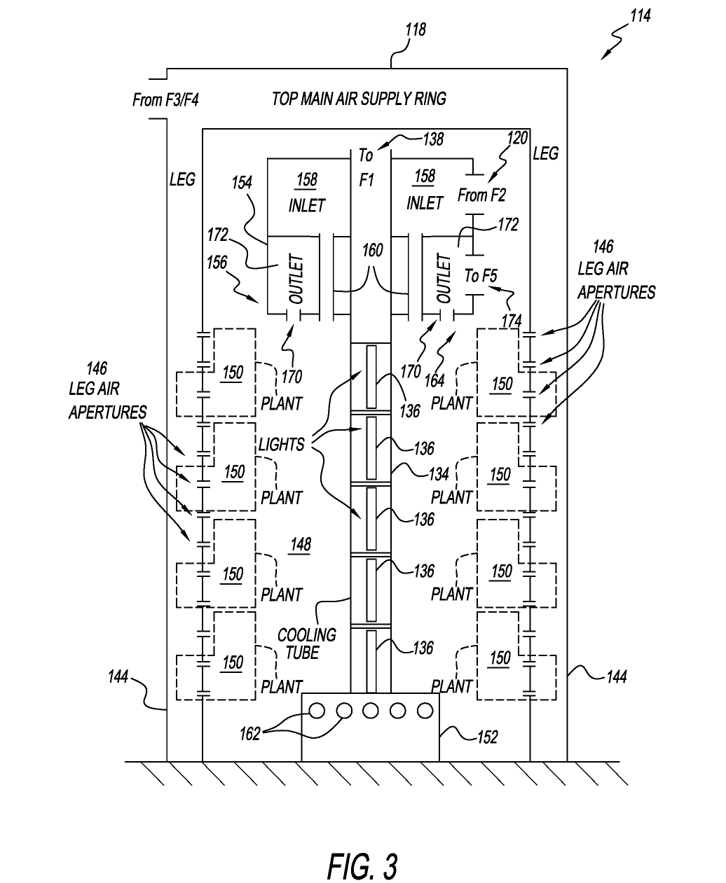

As shown in FIGS. 2 and 3, this section describes a vertical growing system 110 that is an example of the system described generally in the Overview and Section A above. FIG. 2 is a schematic diagram of an HVAC system 112 coupled to a single growing tower 114. In practice, a plurality of towers such as tower 114 may be utilized. A single tower is shown here for convenience and efficiency of explanation. FIG. 3 is a schematic sectional elevation view of growing tower 114, showing relationships between components of the tower. Both of these diagrams will be used again in later sections to illustrate different modes of operation.

With specific reference to the schematic diagrams of FIGS. 2 and 3, vertical growing system 110 will now be described.

As shown in FIG. 2, HVAC system 112 of growing system 110 includes an air control room 116 (also referred to as a plenum or a space), which is configured to supply dehumidified and temperature controlled air to a top air supply ring 118 and/or a side air inlet 120 of one or more growing towers (e.g., tower 114). The air control plenum is also configured to receive supply air from the exterior atmosphere (i.e., outside air) via a damper E and an exterior supply line 122, from a damper H and an exhaust return line 124, and/or from a “hot box” or hot air plenum 126 via a damper B and a hot air line 128. The term “line” may be used interchangeably herein with the term “duct.” The temperature of the air in air control plenum 116 may be adjusted and controlled by mixing the various air sources, by controlling the air flow through the space, by controlled use of an associated cooler 130, or by any combination of these. Cooler 130 may be of the type used in walk-in refrigeration units. The air in air control plenum 116 may further be conditioned using a dehumidifier 132 (e.g., controlled at about 30% to about 35% humidity levels).

Hot box 126 functions as either a flow-through space or as a plenum for receiving heated air from the one or more growing towers 114. This air has been heated using a heater in the hot box and/or by passing it through a cooling tube 134 in each tower. Air flow through the cooling tube is used to cool one or more lights 136 in the tower (see FIG. 3). Lights 136 may be referred to as grow lights, and may include any suitable lighting device configured to promote the healthy growth of nearby plants. For example, lights 136 may comprise high-pressure sodium lights or the like.

A first fan F1 associated with each tower may be on (e.g., continuously) to draw air from cooling tube 134 to hot box 126, through a top opening 138 in the central column of tower 114. Optionally, hot box 126 may further contain a dehumidifier 140 and/or a furnace or heater 142. As shown in FIG. 2, air from the hot box may be directed to air control plenum 116 via hot air line 128 (e.g., through a damper B), to the outside atmosphere (e.g., through a damper C), and/or back to inlet 120 of tower 114 (e.g., through a damper A). Heater 142 may be utilized to more rapidly warm up the air when a “plant day” mode is entered and/or to provide faster heat bursts with less build-up time when a mold-killing mode is enabled (see Section D below). Because the heat burst mode generally excludes the air control plenum and its associated dehumidifier, humidity levels may be further controlled (e.g., in the 30-35% range) using dehumidifier 140.

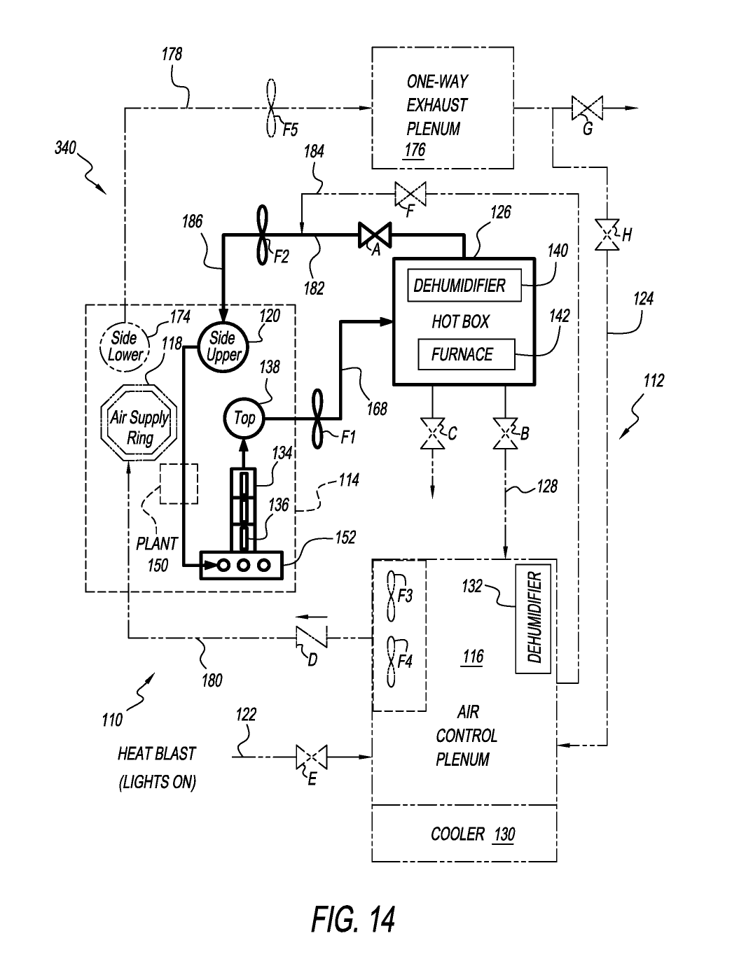

With continuing reference to FIGS. 2 and 3, each tower may include inlets and outlets coupled to the HVAC system by various ducts. As described above, and with specific reference to FIG. 3, top air supply ring 118 may receive air from air control plenum 116, and direct it down a plurality of legs 144, each of which may include several smaller openings or apertures 146 (see also FIG. 14) to effectively spray the air into a space or a volume 148 occupied by plants 150 supported by the tower. As shown in FIG. 3 and in the example of FIG. 13, plants may be placed around a periphery of the tower (i.e., in the tower walls), supported on substantially horizontal shelves.

Cooling tube 134 (which contains grow lights 136) in combination with a lower intake portion 152 and an upper air manifold 154 comprise a central column 156 of the grow tower. In this example, central column 156 is generally freestanding with respect to the outer legs 144 and upper air supply ring 118. In some examples, one or more features may couple the central column to the outer legs and/or upper ring, e.g., for structural support, alignment, and/or the like. Because of the design of the tower, and the central column of grow lights, plants 150 will generally grow toward the axial center of the tower and then upward (as shown schematically in FIG. 3).

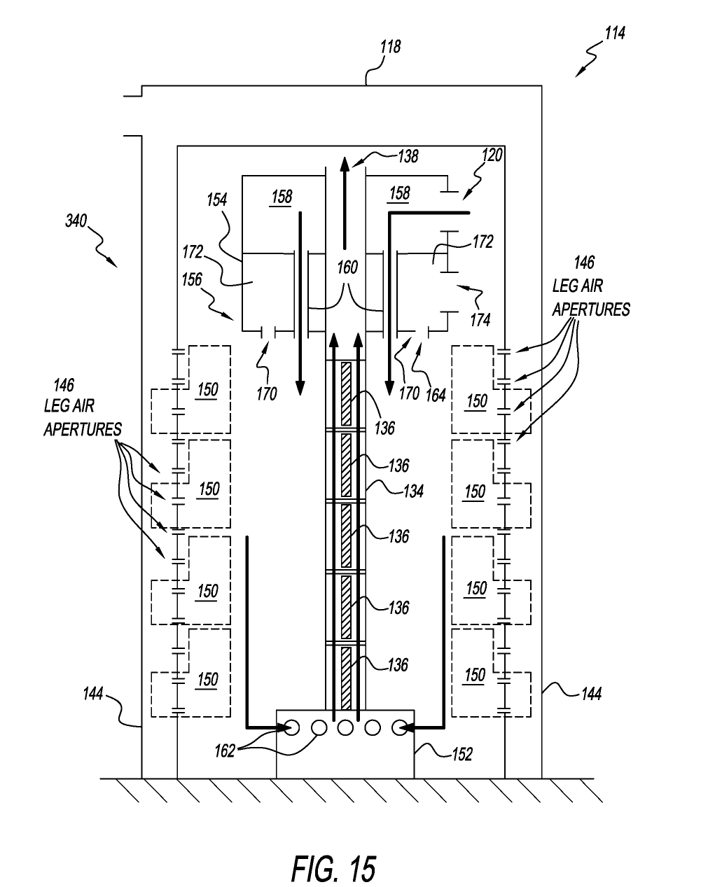

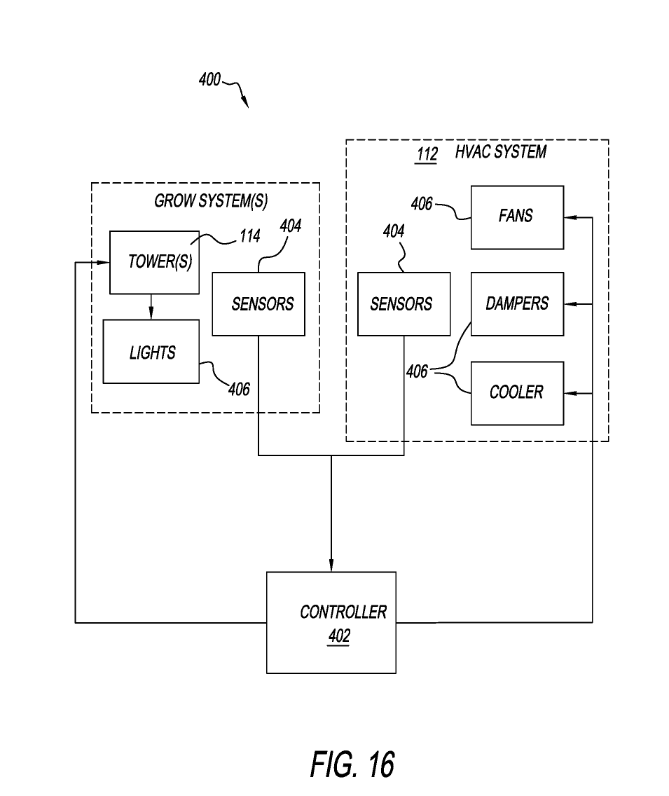

Side inlet 120 is present on air manifold 154 of the central column, connectible to hot box 126 via damper A and a fan F2 and/or to air control plenum 116 via a damper F and fan F2 (see FIG. 2). As shown in FIG. 3 (and FIGS. 15-16), air can flow through inlet 120 to an inlet ring 158 (AKA the inlet annulus), then through one or more downward internal passages 160 and into interior volume 148 of the tower.

Air will generally exit interior volume 148 of the tower through either lower intake portion 152 (AKA the base) of central column 156 or through an outlet portion 164 of the top air manifold 154, or both. The air exit path via lower intake portion 152 is independent of the air exit path via outlet portion 164. Specifically, air passing through lower intake portion 152 is drawn upward through one or more first inlet openings 162 and through central cooling tube 134, past the several grow lights 136, and to hot box 126 through top outlet 138 of the central column. This air flow is facilitated by a fan F1, which is disposed in an exit line 168 coupling the central column to the hot box. In some examples, this air passes through a filter.

In contrast, air passing through outlet portion 164 enters one or more second inlet openings 170 (e.g., in an underside) of air manifold 154 and passes into an outlet ring 172. The air then exits through a side outlet 174 to an exhaust plenum 176 of HVAC system 112 via an exhaust line 178. Supplemental air flow out of tower 114 may be caused by opening an exit damper G of exhaust plenum 176 and powering a fan F5 disposed in line 178 (see FIG. 2).

Fan F5 may have a higher flow capacity than fan F1, such that when fan F5 is engaged, a majority (e.g., 12/13) of the air flow exits through outlet portion 164 of the air manifold and a minority (e.g., ⅓) of the air exits through lower intake portion 152 and cooling tube 134. This would normally cause an imbalance, so a corresponding higher-flow supply fan F4 may be engaged simultaneously to ensure balanced flow from air control plenum 116 to air supply ring 118 via supply line 80 and a one-way damper D. Fan F4 and a second supply fan F3, may be housed in a portion of air control room 116. More specifically, supply fan F3 may be an eight-inch fan, which is typically balanced with eight-inch exhaust fan F1 (from tower to hot box). Supply fan F4 may be a larger, ten-inch fan, which is balanced by ten-inch fan F5. In some examples, fans F3 and F1 are run continuously in a given mode, while fans F4 and F5 are run (in tandem) as needed. In some examples, fan F2 is also an eight-inch fan that can be balanced with fan F1, e.g., in heat burst mode (see below). Fans F1 through F5 may each include any suitable fan configured to move air through a duct at desired rates. For example, inline centrifugal duct fans sold under the FanTech® brand may be suitable for this purpose. Flow rates in the interior space of each tower may be significantly higher than those experienced in existing systems. For example, air flow rates in the vicinity of the plants may be from about 800 cubic feet per minute (cfm) to about 2000 cfm, depending on the mode and the number of fans in operation. For example, eight-inch fans may move air at around 800 cfm, while ten-inch fans move air at around 1200 cfm, such that the combination of both types moves air at around 2000 cfm.

In some examples, air flow may be selectively directed from exhaust plenum 176 to exit damper G, which causes flow to the exterior environment, and/or to damper H, which causes flow back to air control plenum 116 via return line 124, e.g., for temperature control purposes.

Various combinations of the above-described heat sources, cooling sources, damper positions, fans, air inlets and outlets, etc., may be selected using a control system and/or manual operation to achieve various desired outcomes. Some examples of these modes or configurations are described further below (e.g., see Section D).

Fans F1, F2, F3, F4, and F5, as well as their associated dampers and ducts, may all be associated with a single tower 114, collectively forming a repeatable and individually-controllable system connected to the main plenums. In other words, for a given number of towers 114, a corresponding number of fans F1, fans F2, etc., may be provided. Accordingly, hot box 126, air control plenum 116, and exhaust plenum 176 each have a plurality of inlet and outlet lines, depending on the number of towers in system 110. For example, if there are twelve towers, then exhaust plenum 176 will be coupled to twelve lines 178 coming from the outlets of twelve upper air manifolds, each with a respective fan F5. Among other things, this arrangement facilitates individual tailoring of air flows and temperatures in each of the towers.

### C. Illustrative Growing Tower

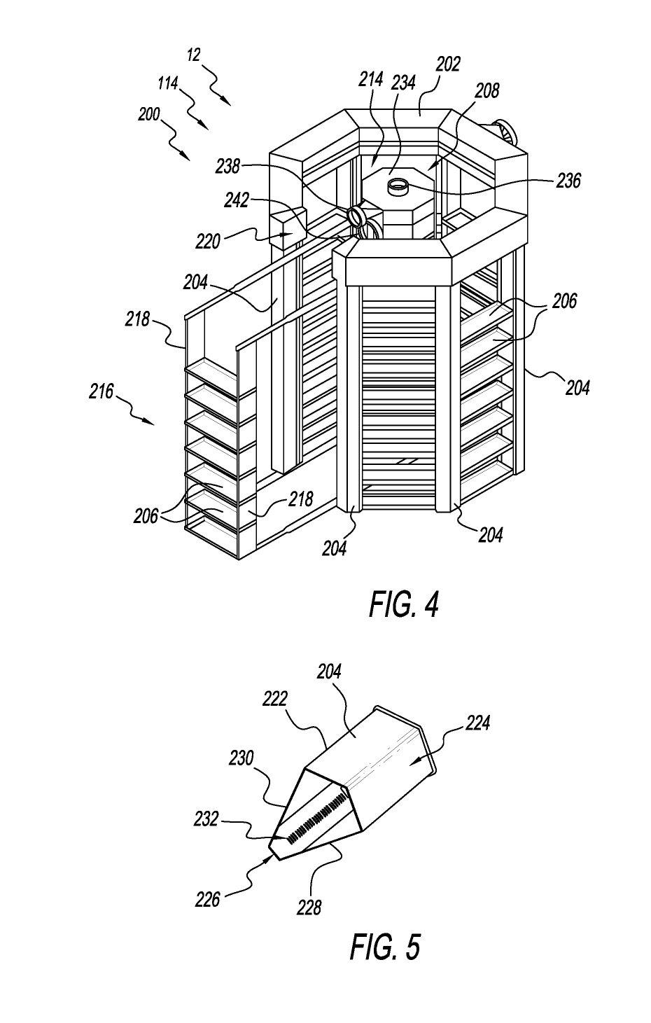

As shown in FIGS. 4 through 9, this section describes an illustrative vertical growing tower 200, which is an example of tower 114 and suitable for use with HVAC system 112 of FIG. 2, described above.

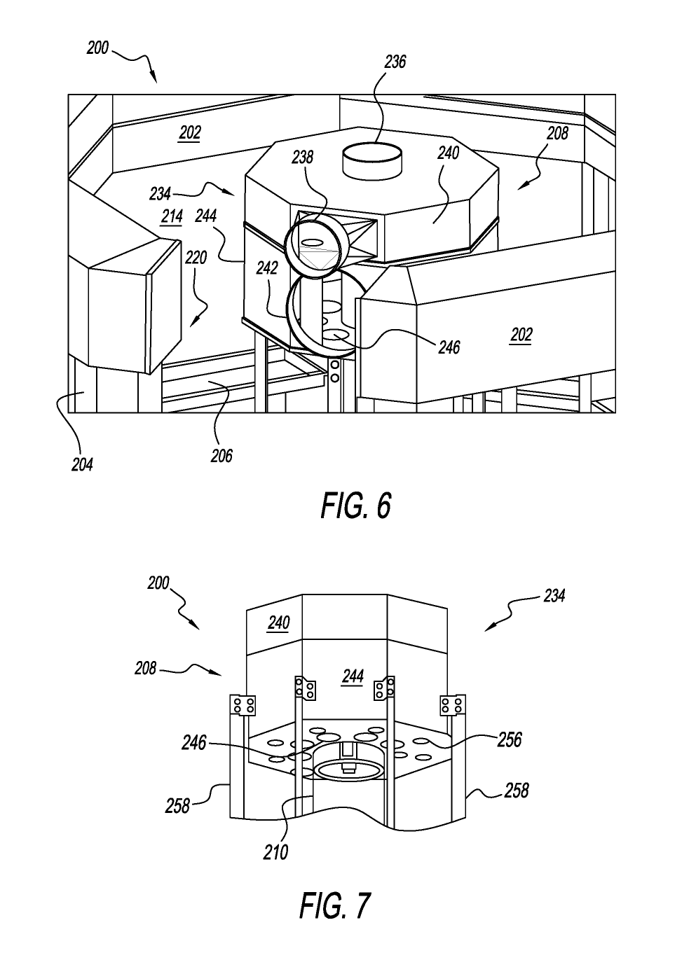

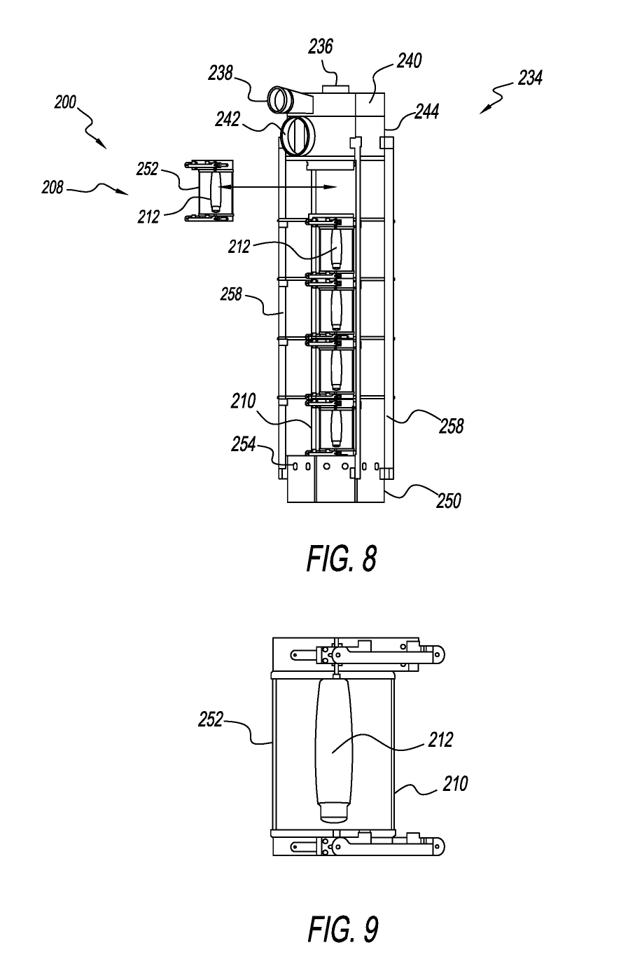

FIG. 4 is an isometric view of vertical growing tower 200, which operates according to aspects of tower 114. FIG. 5 is an isometric view of a section of one of the vertical legs of tower 200, showing internal structure. FIGS. 6 and 7 are two different magnified views of an upper portion of the central column of tower 200. FIG. 8 shows the central column in elevation view, and FIG. 9 is a light module of the central column.

With specific reference to FIGS. 4 through 9 and general reference to the schematic diagrams of FIGS. 2 and 3, vertical growing tower 200 will now be described. Unless stated otherwise, components of tower 200 should be understood to have functionality substantially identical to that of their counterparts in tower 114, as described elsewhere in this disclosure.

As shown in FIG. 4, tower 200 comprises an octagonal outer structure or plant stand having an upper supply ring 202 and eight vertical legs 204. Multiple shelves 206 (AKA platforms) for holding plants (e.g., in pots) span the spaces between each pair of adjacent legs, forming or defining walls of the plant stand portion of the tower. In this example, each inter-leg space includes seven such shelves, although more or fewer may be present, and different spaces may include different numbers of shelves. For example, tower 200 may have four shelves 206 in each wall.

A central column 208 is substantially coaxial with and has a height similar to the outer ring. As shown in FIG. 4, the vertical extent of shelves 206 may correspond generally to the vertical extent of a cooling tube portion 210 of the central column, because the cooling tube houses a plurality of grow lights 212. As described above with respect to tower 114, an annular column of interior volume 214 exists between central column 208 and the outer perimeter formed by shelves 206 and legs 204. Plants, disposed on shelves 206, are encouraged to grow into interior space 214 by the lighting provided by grow lights 212 and to some extent by the air flow created by HVAC system 112 and the tower.

In this example, one section or wall 216 of shelves 206 of the octagonal tower may be selectively repositionable (i.e., removable and reinstallable). For example, as shown in FIG. 4, wall 216 of shelves 206 may slide or otherwise translate radially outward, e.g., on telescoping rails. This feature may be included to permit entry into the interior of the tower for tending plants, maintaining the lights, etc. Side supports 218 may be included to maintain the integrity of wall 216 without connecting the shelves to adjacent legs 204. In some examples, wall 216 may, alternatively or additionally, pivot (e.g., like a hinged door) or slide to one side.

Hoop structures and/or hooks may be included on inward-facing surfaces of the octagonal tower, for retaining the plants. Wall section 216 may have independent versions of these hoop structures, such that the plants are still retained against the removable wall section when it is pulled out. To facilitate the repositionability of wall 216, upper air supply ring 202 may terminate at the upper ends of the legs on either side of the wall, such that a gap 220 is formed in the ring (see FIG. 4). In some examples, no gap may be present, such that air supply ring 202 forms a full annulus and wall 216 is repositionable below the ring.

Although this embodiment is shown and described in terms of an octagonal shape, any suitable shape may be used, including a substantially cylindrical shape or other polygonal shapes.

FIG. 5 depicts an illustrative leg portion 222 of one of legs 204. Leg portion 222 is a hollow, wedge-shaped tube having an outboard face 224, an inboard face 226, and a pair of narrowing sidewalls 228 and 230. Inboard face 226 includes a plurality of apertures 232, corresponding to air-spraying apertures 146 of tower 114.

FIGS. 6 and 7 show additional details of an upper air manifold 234 of central column 208. In this example, upper air manifold 234 is generally eight-sided (i.e., octagonal), with substantially flat upper and lower surfaces. However, any suitable shape and size may be utilized, such as a circular shape or a polygonal shape with more or fewer sides. A top outlet 236 on an upper surface of air manifold 234 provides an outlet for air exiting the cooling tube of central column 208 (e.g., to fan F1). An upper side inlet 238 provides a path for air from hot box 126 and/or air control plenum 116 (e.g., from fan F2) to enter an inlet annulus 240 of the air manifold. A lower side outlet 242 provides a path for air from an outlet annulus 244 of the air manifold to exit toward exhaust plenum 176 (e.g., to fan F5). A plurality of inlet openings 246 in a lower surface of air manifold 234 (corresponding to second inlet openings 170) provide a path for air from interior space 214 to exit via outlet annulus 244 and side outlet 242.

As shown in FIGS. 7 and 8, central cooling tube 210 is coupled to the lower surface of the upper air manifold, such that air within the tube is in communication with top outlet 236 (see FIG. 3). Central cooling tube 210 may include any suitable enclosure configured to provide a communication pathway for air to pass by and around a series of lighting elements 248 (AKA grow lights) between upper air manifold 234 and a lower intake portion 250 of the central column (corresponding to lower intake 52). In this example, central cooling tube 210 comprises a plurality of lighting modules 252 (AKA modular lamps) (see FIGS. 7 and 9). Each of the lighting modules includes a central lighting element 248 surrounded by a substantially cylindrical, transparent or translucent housing that is open at its upper and lower ends. Lighting modules 252 are coupled together in a stack, to form a continuous, hollow tube (i.e., central cooling tube 210) around the lighting elements. Air can flow from a plurality of intake holes 254 of lower intake portion 250, up around lighting elements 248 and through the top outlet aperture of the manifold. Releasable latching mechanisms are included between lighting modules, such that any one of the modules can be removed and reinstalled as needed, e.g., for cleaning or for replacing a lighting element (see FIG. 8). This modular design greatly simplifies maintenance of the lighting system. In some examples, each lighting module 252 may contain more than one lighting element (side by side and/or vertically stacked). In some examples, the entire central cooling tube may include a single removable lighting module 252, enclosing a plurality of lighting elements.

Lower intake portion 250 is an enlarged base of the central column, which includes intake holes 254 around an outer periphery and an upper outlet for communication with the central cooling tube. In some examples, the body of lower intake portion 250 may house an air filter, e.g., a high efficiency particulate air (HEPA) filter. In this example, a plurality of vertical support rails 258 structurally connect upper air manifold 234 to lower intake portion 250. This provides support, spacing, and alignment, and permits the independent removal of lighting modules 252.

In some examples, tower 200 may be approximately nine feet tall, with a ten-foot inner diameter. Central cooling tube may be about eight inches in diameter. In this example of tower 200, air in interior volume 214 is exchanged (i.e., replaced) at a rate of about once every twenty seconds when using the eight and ten inch fans described above with respect to HVAC system 112.

### D. Illustrative Operating Modes

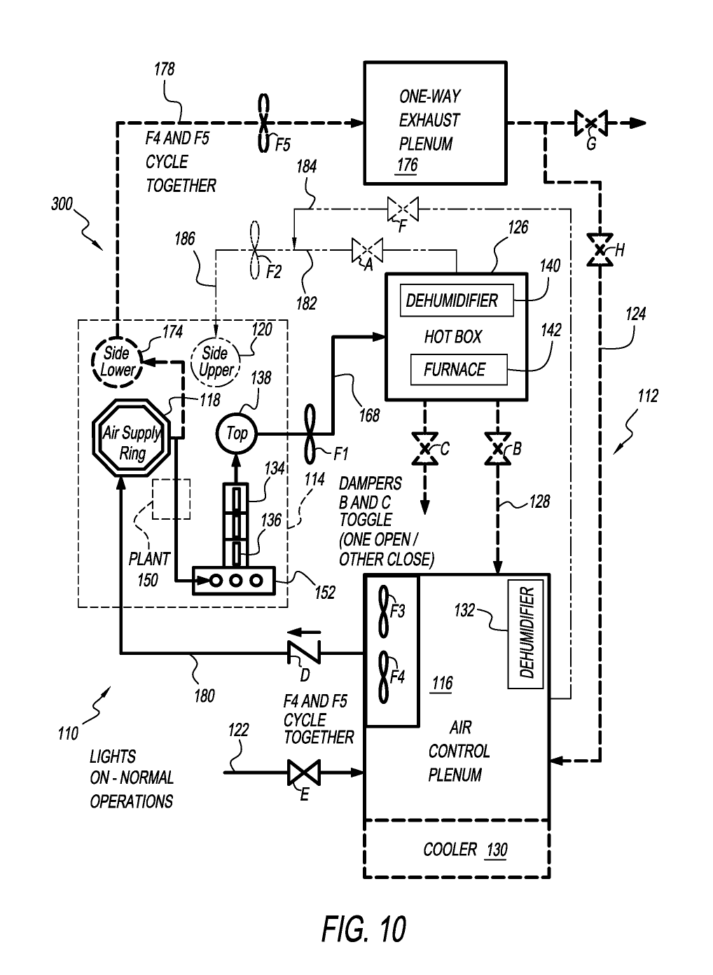

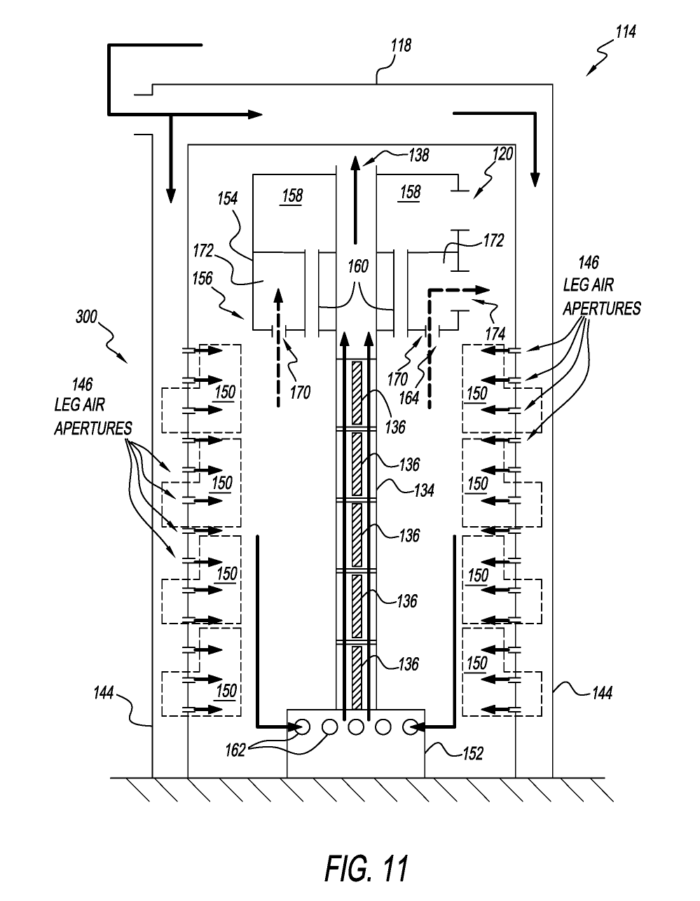

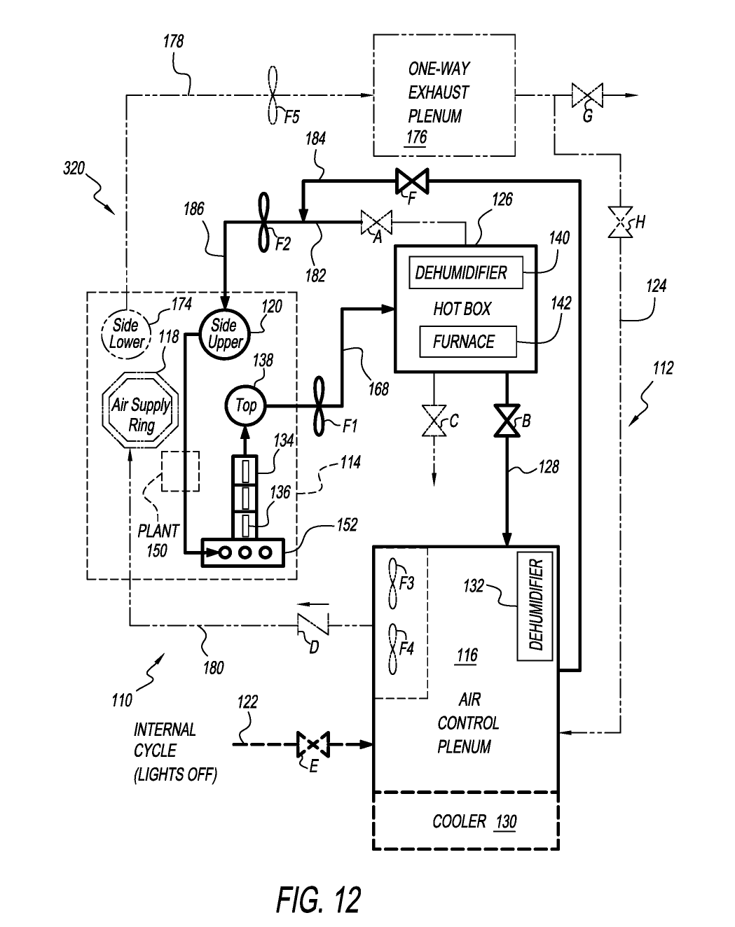

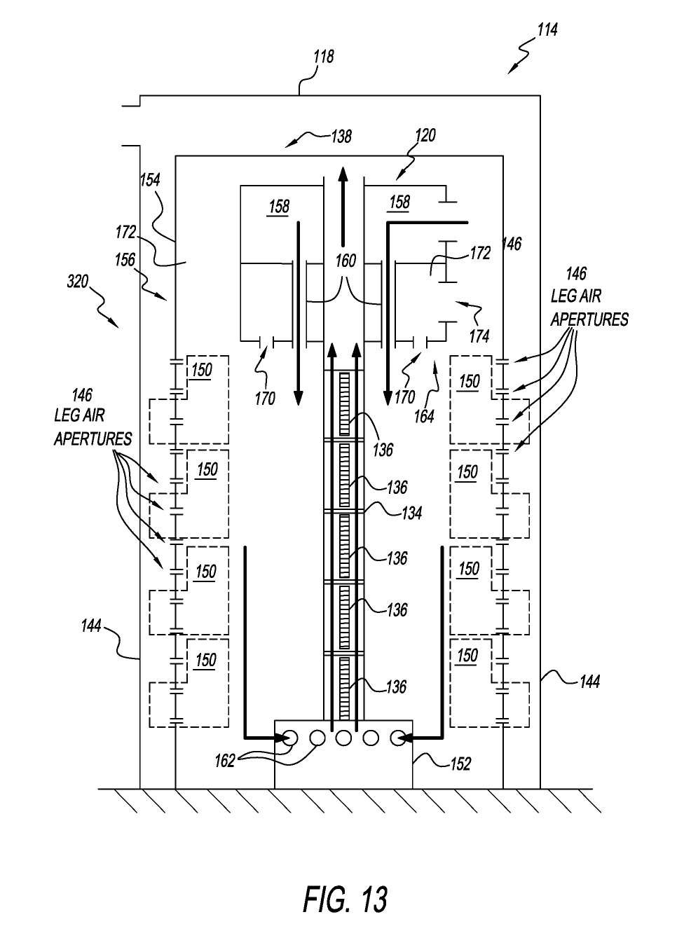

As shown in FIGS. 10-15, this section describes several operating modes that can be selectively implemented and controlled utilizing the plant growing systems described above and shown in the drawings. FIGS. 10 and 11 show a first mode, with the lights on. FIGS. 12 and 13 show a second mode, with the lights off. Finally, FIGS. 14 and 15 show a third mode, for providing a burst of heat to the plants to inhibit mold growth. Selected sub-modes and/or alternatives are described as well.

Referring to FIGS. 10 and 11, system 110 is shown in a first mode 300, which may be referred to as the “Plant Day” mode and/or the “Normal Operations—Lights On” mode. This mode is typically utilized during human nighttime hours, when outside temperatures are lower. In mode 300, air is generally circulated between air control plenum 116, tower(s) 114, and hot box 126, with the grow lights turned on. Air flows through HVAC system 112 are depicted in FIG. 10. Generally speaking, in all of the diagrams described in this section, heavy solid lines are used to indicate “on” or “open” or “flowing”; light, broken lines are used to indicate “off” or “shut” or “not flowing”; and heavy, broken lines are used to indicate “cycling” or “controlled to be on or off, open or shut”

The heated air from the hot grow lights of tower(s) 114 is sent to air control plenum 116, via hot box 126, generally driven by fans F1 in duct 168 and fan F3 in the air control plenum. In the air control plenum, air is cooled by cycling cooler 130 and/or letting in outdoor air via damper E. Additionally or alternatively, flow may be controlled by cycling fans F4 (supply) and F5 (exhaust) together to increase flow through tower(s) 114, as needed. An additional control is possible by dumping hot air from hot box 126 into the outside environment, as needed, through damper C, rather than passing it to air control plenum 116 through damper B. Still another possible control method for temperature and/or flow rates is to loop the exhaust air from exhaust plenum 176 back to the air control plenum via damper H (i.e., with damper G closed). This, for example, results in less of the cooler outdoor air being introduced to the system while still maintaining a high flow rate. In general, temperature in mode 300 is maintained at a mild temperature (e.g., around 65 degrees Fahrenheit (F) in the air control plenum and around 72 F in the vicinity of the plants, or around 70 F in the air control plenum and around 74 F in the vicinity of the plants, or about 65 F to about 74 F). Dampers A and F may remain shut, and fan F2 is off.

Fully transitioning to mode 300 from mode 320 (described below) may be aided or hastened by the temporary use of furnace 142 in heat plenum 126, e.g., for a brief time (e.g., 10-15 minutes) at the start of the plant's day cycle. This causes temperatures to be raised to the optimal growing range more quickly, thereby increasing the amount of time the plants are in growth mode.

Air flows for mode 300 in each tower are shown in FIG. 11. Specifically, air is pulled in through lower intake portion 152 and up through central cooling tube 134, where heat is transferred to the air stream from the powered lighting elements. The heated air then exits the central column via top outlet 138 en route to fan F1 and hot box 126. If fans F4 and F5 are active, flow is also promoted from interior volume 148 through inlet openings 170 in the bottom of upper air manifold 154, into outlet annulus 172, through side outlet 174 en route to fan F5 and exhaust plenum 176. Cooled return air is supplied to plants 150 from air control plenum 116 and damper D, via upper air supply ring 118, down through legs 144, and into interior space 148 through spray apertures 146.

Referring now to FIGS. 12 and 13, system 110 is shown in a second mode 320, which may be referred to as the “Plant Night” mode and/or the “Internal Cycle—Lights Off” mode. This mode is typically utilized during human daytime hours, when outside temperatures are higher. Here, as shown in FIG. 10, air is generally recirculated to tower(s) 114 through side inlet 120 of upper air manifold 154, and returned through central cooling tube 134 (i.e., through lower intake holes 162 and top opening 166). The lights are off, so hot box 126 does not receive heated air as it would when the lights are on (e.g., in mode 300). Air circulates through the hot box and air control plenum 116, where temperature is managed by controlling the intake of outside air (via damper E) and/or by cycling cooler 130 as needed. Specifically, air flows from tower(s) 114 to hot box 126, pulled by fan F1, then from hot box 126 through damper B to air control plenum 116. From there, cooled air flows through damper F, pulled by fan F2 to the upper inlet(s) of the tower(s). Dampers A, C, D, and/or G may remain closed, and fans F3, F4, and F5 are off.

Air flows for mode 320 in each tower 114 are shown in FIG. 13. Specifically, air from interior volume 148 is pulled in through lower intake portion 152 and up through central cooling tube 134. Generally, no heating of this airstream occurs in mode 320, due to the unpowered lighting elements. The air then exits the central column via top outlet 138 en route to fan F1 and hot box 126. Cooled air is supplied from air control plenum 116 by fan F2 through upper inlet 120 of upper air manifold 154, and from there into volume 148 through inlet openings 170.

Temperature may be more easily controlled in mode 320 compared to other modes, as the air is generally being recirculated without much (or any) heat input. To control (or, in some cases, destroy) insects that may be harmful to the plants, this mode may have a “Cold Burst” sub-mode, in which temperature is dropped to near freezing (e.g., approximately 35 F) as needed, for an extended time (e.g., a four-hour cycle). To achieve this temperature drop in mode 320, the same HVAC air flow topology is used, along with extended operation of cooler 130, thereby dropping the temperature to the desired setpoint. This extended but temporary exposure of plants 150 and their surrounding space to near-freezing temperatures effectively controls any harmful insects, thereby reducing or eliminating the need for insecticides.

Referring now to FIGS. 14 and 15, system 110 is shown in a third mode 340, also referred to as the “Heat Blast” and/or “Heat Burst” and/or “Mold Killing” or “Fungus Killing” mode. Like the normal mode (i.e., mode 300), this mode is utilized during a lights-on phase of operation. Here, air heated by grow lights 136 is recirculated in a closed loop including tower(s) 114 and hot box 126 (see FIG. 14). Fans F1 and F2 are energized to cause the flow, with damper A open (all other dampers may be shut). This mode is used to kill undesirable mold(s) and/or other fungi that may be undesirable in terms of plant health.

This closed-loop circulation of air with the grow lights energized raises the air temperature to a level sufficient to kill or control harmful mold growth (e.g., from 92 F to 98 F, to about 95 F, or to about 98 F). After a selected number of minutes (e.g., five minutes from the time the plant area reaches 92 F, or until temperature inside the tower(s) reaches 98 F, whichever comes first), heat burst mode 340 is ended, and operations are returned to normal mode 300 at lower temperatures. This heat burst mode may be performed multiple times a day, and/or on a periodic basis. In some examples, furnace 142 may be cycled on as needed to increase the air temperature and reach the heat-burst setpoint more quickly. On an as-needed basis, such as when a given tower is reaching an undesirable over-temperature condition, the fans F4 and F5 associated with that tower may be used to temporarily circulate air through an unheated second loop (via damper H and air control plenum 116), thereby increasing the air flow and reducing the rate of temperature increase in that tower. (This option is not depicted in FIGS. 14-15, but the corresponding flow paths are shown in FIGS. 10-11, with respect to mode 300. A similar option is available in mode 320.)

Airflows for mode 340 in each tower 114 are shown in FIG. 15. Generally speaking, air flows in the tower are substantially identical to those of mode 320, but with the grow lights turned on. Specifically, air from interior volume 148 is pulled in through lower intake portion 152 and up through central cooling tube 134. This airstream is heated by the powered lighting elements. The air then exits the central column via top outlet 138 en route to fan F1 and hot box 126. Hot air is recirculated back to the tower from hot box 126 by fan F2, through upper inlet 120 of upper air manifold 154. From there it enters volume 148 through inlet openings 170. One or more additional pathways for the heated air may be provided, such that more of the plants' surface area is affected in mode 340. For example, an additional line may be run from duct 186 down (e.g., adjacent to) one or more of the legs of the tower, with outlets at each shelf, directed across the shelf area. Accordingly, additional airflows may be created specific to plants on each shelf supplemental to the generally vertical flow through the interior volume of the tower.

In general, system 110 may be controlled each day in mode 300 for twelve hours, then in mode 320 for twelve hours, to simulate normal plant day/night cycles. Heat burst mode 340 may be performed one or more times per day. Cold burst mode may be performed periodically and/or on an as-needed basis, such as when insects are observed on the plants.

### E. Illustrative Control System

As shown in the schematic diagram of FIG. 16, this section describes an illustrative control system 400 suitable for use with plant growing systems 10 and/or 110 described above. As depicted in FIG. 16, a controller 402, which may be an example of a data processing device (see Section F), receives inputs and controls outputs according to a programmed set of instructions. Controller 402 may include a programmable logic controller (PLC), (see Section G).

Inputs to the controller include sensor readings from one or more vertical tower grow systems 114 and from an associated HVAC system 112. Towers 114 and HVAC system 112 may include a plurality of sensors 404, such as sensors for temperature, pressure, humidity, noise, vibration, damper position, and/or the like, or any combination of these. The sensors may be in various locations, such as tower interiors, ductwork, fans, plenums, etc.

Outputs from controller 402 may correspond to any suitable devices 406 or systems configured to be controlled (e.g., devices 22 of FIG. 1). Controllable devices 406 may include grow lights 136 in the towers, fans (e.g., fans F1 through F5), dampers (e.g., dampers A through H), cooler(s) (e.g., cooler 130), and/or dehumidifiers (e.g., dehumidifiers 132 and 140) in HVAC system 112, and/or any other controllable devices. The controller may be configured to operate in predefined modes, as described above (e.g., modes 300, 320, 340), and may also permit interactive manual operation and/or setpoint manipulation.

### F. Illustrative Data Processing System

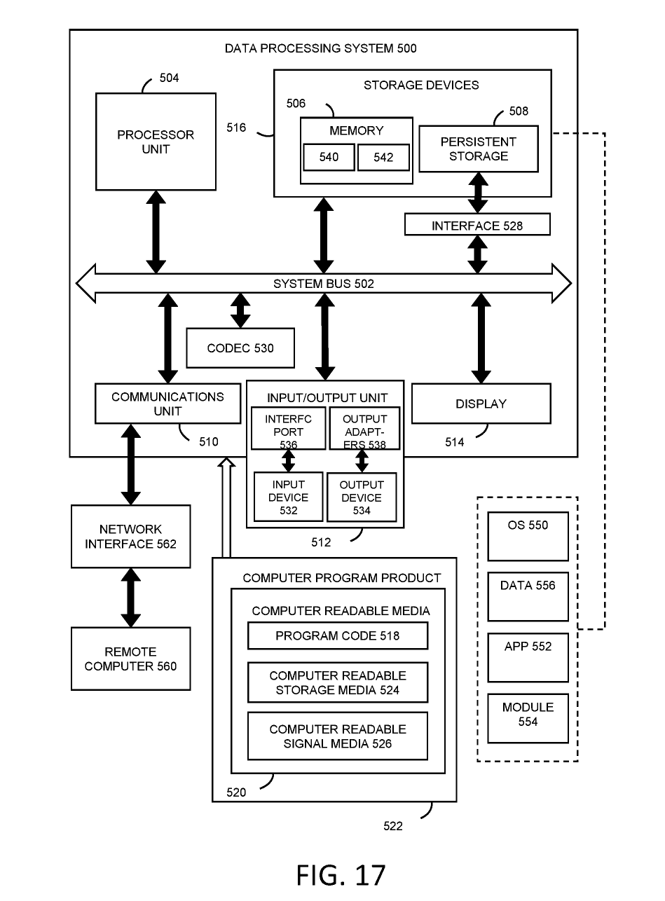

As shown in FIG. 17, this example describes a data processing system 500 (also referred to as a computer, computing system, and/or computer system) in accordance with aspects of the present disclosure. In this example, data processing system 500 is an illustrative data processing system suitable for implementing aspects of the vertical plant growing systems and methods described herein. More specifically, in some examples, devices that are embodiments of data processing systems (e.g., smartphones, tablets, personal computers) may may run programmed algorithms to place the growing system into one or more modes, or may provide user interfaces for interfacing with or manually controlling aspects of the system. In some embodiments, smart devices, such as a tablet or smart phone, may be utilized to access and interface with control system 400, e.g., remotely or over a wireless network. In some examples, controller 402 may comprise a data processing system, as described below.

In this illustrative example, data processing system 500 includes a system bus 502 (also referred to as communications framework). System bus 502 may provide communications between a processor unit 504 (also referred to as a processor or processors), a memory 506, a persistent storage 508, a communications unit 510, an input/output (I/O) unit 512, a codec 530, and/or a display 514. Memory 506, persistent storage 508, communications unit 510, input/output (I/O) unit 512, display 514, and codec 530 are examples of resources that may be accessible by processor unit 504 via system bus 502.

Processor unit 504 serves to run instructions that may be loaded into memory 506. Processor unit 504 may comprise a number of processors, a multi-processor core, and/or a particular type of processor or processors (e.g., a central processing unit (CPU), graphics processing unit (GPU), etc.), depending on the particular implementation. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device may include any suitable hardware capable of storing information (e.g., digital information), such as data, program code in functional form, and/or other suitable information, either on a temporary basis or a permanent basis.

Storage devices 516 also may be referred to as computer-readable storage devices or computer-readable media. Memory 506 may include a volatile storage memory 540 and a non-volatile memory 542. In some examples, a basic input/output system (BIOS), containing the basic routines to transfer information between elements within the data processing system 500, such as during start-up, may be stored in non-volatile memory 542. Persistent storage 508 may take various forms, depending on the particular implementation.

Persistent storage 508 may contain one or more components or devices. For example, persistent storage 508 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 508 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 508 to system bus 502, a removable or non-removable interface is typically used, such as interface 528.

Input/output (I/O) unit 512 allows for input and output of data with other devices that may be connected to data processing system 500 (i.e., input devices and output devices). For example, input device 532 may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 504 through system bus 502 via interface port(s) 536. Interface port(s) 536 may include, for example, a serial port, a parallel port, a game port, and/or a universal serial bus (USB).

Output devices 534 may use some of the same types of ports, and in some cases the same actual ports, as input device(s) 532. For example, a USB port may be used to provide input to data processing system 500 and to output information from data processing system 500 to an output device 534. Output adapter 538 is provided to illustrate that there are some output devices 534 (e.g., monitors, speakers, and printers, among others) which require special adapters. Output adapters 538 may include, e.g. video and sounds cards that provide a means of connection between the output device 534 and system bus 502. Other devices and/or systems of devices may provide both input and output capabilities, such as remote computer(s) 560. Display 514 may include any suitable human-machine interface or other mechanism configured to display information to a user, e.g., a CRT, LED, or LCD monitor or screen, etc.

Communications unit 510 refers to any suitable hardware and/or software employed to provide for communications with other data processing systems or devices. While communication unit 510 is shown inside data processing system 500, it may in some examples be at least partially external to data processing system 500. Communications unit 510 may include internal and external technologies, e.g., modems (including regular telephone grade modems, cable modems, and DSL modems), ISDN adapters, and/or wired and wireless Ethernet cards, hubs, routers, etc. Data processing system 500 may operate in a networked environment, using logical connections to one or more remote computers 560. A remote computer(s) 560 may include a personal computer (PC), a server, a router, a network PC, a workstation, a microprocessor-based appliance, a peer device, a smart phone, a tablet, another network note, and/or the like. Remote computer(s) 560 typically include many of the elements described relative to data processing system 500. Remote computer(s) 560 may be logically connected to data processing system 500 through a network interface 562 which is connected to data processing system 500 via communications unit 510. Network interface 562 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 530 may include an encoder, a decoder, or both, comprising hardware, software, or a combination of hardware and software. Codec 530 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 530 is depicted as a separate component, codec 530 may be contained or implemented in memory, e.g., non-volatile memory 542.

Non-volatile memory 542 may include read only memory (ROM), programmable ROM (PROM), electrically programmable ROM (EPROM), electrically erasable programmable ROM (EEPROM), flash memory, and/or the like, or any combination of these. Volatile memory 540 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 516, which are in communication with processor unit 504 through system bus 502. In these illustrative examples, the instructions are in a functional form in persistent storage 508. These instructions may be loaded into memory 506 for execution by processor unit 504. Processes of one or more embodiments of the present disclosure may be performed by processor unit 504 using computer-implemented instructions, which may be located in a memory, such as memory 506.

These instructions are referred to as program instructions, program code, computer usable program code, or computer-readable program code executed by a processor in processor unit 504. The program code in the different embodiments may be embodied on different physical or computer-readable storage media, such as memory 506 or persistent storage 508. Program code 518 may be located in a functional form on computer-readable media 520 that is selectively removable and may be loaded onto or transferred to data processing system 500 for execution by processor unit 504. Program code 518 and computer-readable media 520 form computer program product 522 in these examples. In one example, computer-readable media 520 may comprise computer-readable storage media 524 or computer-readable signal media 526.

Computer-readable storage media 524 may include, for example, an optical or magnetic disk that is inserted or placed into a drive or other device that is part of persistent storage 508 for transfer onto a storage device, such as a hard drive, that is part of persistent storage 508. Computer-readable storage media 524 also may take the form of a persistent storage, such as a hard drive, a thumb drive, or a flash memory, that is connected to data processing system 500. In some instances, computer-readable storage media 524 may not be removable from data processing system 500.

In these examples, computer-readable storage media 524 is a non-transitory, physical or tangible storage device used to store program code 518 rather than a medium that propagates or transmits program code 518. Computer-readable storage media 524 is also referred to as a computer-readable tangible storage device or a computer-readable physical storage device. In other words, computer-readable storage media 524 is media that can be touched by a person.

Alternatively, program code 518 may be transferred to data processing system 500, e.g., remotely over a network, using computer-readable signal media 526. Computer-readable signal media 526 may be, for example, a propagated data signal containing program code 518. For example, computer-readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 518 may be downloaded over a network to persistent storage 508 from another device or data processing system through computer-readable signal media 526 for use within data processing system 500. For instance, program code stored in a computer-readable storage medium in a server data processing system may be downloaded over a network from the server to data processing system 500. The computer providing program code 518 may be a server computer, a client computer, or some other device capable of storing and transmitting program code 518.

In some examples, program code 518 may comprise an operating system (OS) 550. Operating system 550, which may be stored on persistent storage 508, controls and allocates resources of data processing system 500. One or more applications 552 take advantage of the operating system's management of resources via program modules 554, and program data 556 stored on storage devices 516. OS 550 may include any suitable software system configured to manage and expose hardware resources of computer 500 for sharing and use by applications 552. In some examples, OS 550 provides application programming interfaces (APIs) that facilitate connection of different type of hardware and/or provide applications 552 access to hardware and OS services. In some examples, certain applications 552 may provide further services for use by other applications 552, e.g., as is the case with so-called “middleware.” Aspects of present disclosure may be implemented with respect to various operating systems or combinations of operating systems.

The different components illustrated for data processing system 500 are not meant to provide architectural limitations to the manner in which different embodiments may be implemented. One or more embodiments of the present disclosure may be implemented in a data processing system that includes fewer components or includes components in addition to and/or in place of those illustrated for computer 500. Other components shown in FIG. 17 can be varied from the examples depicted. Different embodiments may be implemented using any hardware device or system capable of running program code. As one example, data processing system 500 may include organic components integrated with inorganic components and/or may be comprised entirely of organic components (excluding a human being). For example, a storage device may be comprised of an organic semiconductor.

In some examples, processor unit 504 may take the form of a hardware unit having hardware circuits that are specifically manufactured or configured for a particular use, or to produce a particular outcome or progress. This type of hardware may perform operations without needing program code 518 to be loaded into a memory from a storage device to be configured to perform the operations. For example, processor unit 504 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 518) may be implemented as hardware, e.g., by specifying an FPGA configuration using a hardware description language (HDL) and then using a resulting binary file to (re)configure the FPGA.

In another example, data processing system 800 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

In another example, system bus 502 may comprise one or more buses, such as a system bus or an input/output bus. Of course, the bus system may be implemented using any suitable type of architecture that provides for a transfer of data between different components or devices attached to the bus system. System bus 502 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 510 may include a number of devices that transmit data, receive data, or both transmit and receive data. Communications unit 510 may be, for example, a modem or a network adapter, two network adapters, or some combination thereof. Further, a memory may be, for example, memory 506, or a cache, such as that found in an interface and memory controller hub that may be present in system bus 502.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### G. Illustrative Programmable Logic Controller

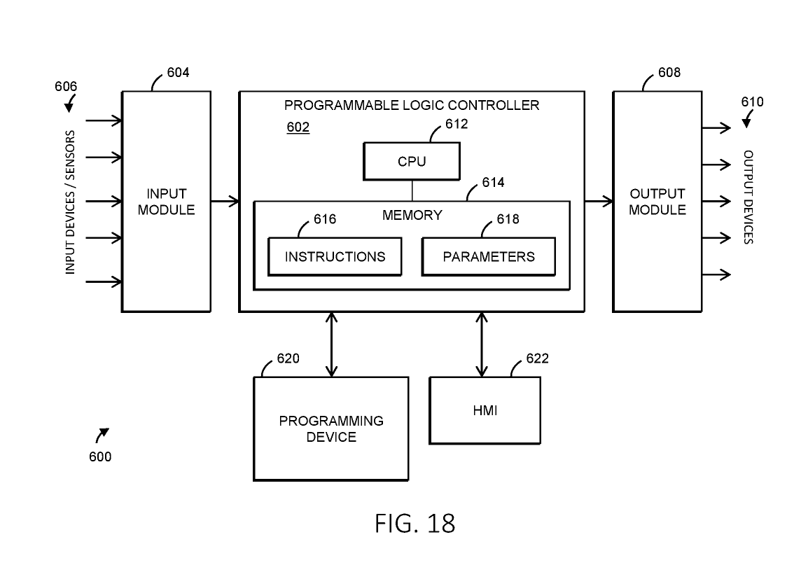

As shown in FIG. 18, this section describes an illustrative programmable logic controller system 600 (also referred to as a PLC system) suitable for implementing aspects of vertical plant growing system controls, in accordance with aspects of the present disclosure. PLC system 600 is a programmable controller used for automation of typical industrial processes, and is an embodiment of data processing system 500, described above. In some examples, devices that are embodiments of a programmable logic controller system may be included in control system 400 (e.g., as controller 402).

In this illustrative example, PLC system 600 includes a programmable logic controller (PLC) 602, also referred to as a controller. PLC 602 includes a central processing unit (CPU) 612, and a memory 614 for storing instructions 616 and parameters 618 necessary to carry out the relevant automation tasks.

Central processing unit 612 is an example of processor unit 504, described above, and serves to execute software programs in the form of instructions 616. The software programs may be loaded into memory 614. Memory 614, which is an example of storage device 516 described above, may also store parameters 618 needed for operation. A programming device 620 may interface with PLC 602 to facilitate the input of instructions and settings and/or to monitor equipment operation. Programming device 620 may include, for example, a handheld computer or personal computer.

A human machine interface (HMI) 622 may also be placed in communication with PLC 602. HMI 622 facilitates a user-friendly and interactive interface with the system processes and controls. Human machine interface 622 may also assist an operator in determining machine conditions, in changing machine settings, and/or displaying faults.

PLC system 600 includes an input module 604 in receiving communication with one or more input devices/sensors 606, and an output module 608 in outgoing communication with one or more output devices 610. Both modules 604 and 608 are hardware devices in communication with PLC 602. In some examples, communication with PLC 602 may be carried out via an optical (or otherwise wireless) interface, such that PLC 602 is electrically isolated from the input and output modules.

Input module 604 may convert analog signals from input devices/sensors 606 into digital and/or logic signals that the PLC can use. Signal types may be digital or analog. With these signals the CPU may evaluate the status of the inputs. Upon evaluating the input(s), along with known output states and stored program parameters and instructions, the CPU may execute one or more predetermined commands to control the one or more output devices. Output module 608 may convert control signals from the CPU into digital or analog signals which may be used to control the various output devices.

HMI 622 and programming device 620 may provide for communications with other data processing systems or devices, e.g., through the use of physical and/or wireless communications links.

Modules 604 and 608 allow for input and output of data with other devices that may be connected to PLC 602. For example, input module 604 may provide a connection for temperature or pressure measurements, valve or machine status, tank level status, user input through a keyboard, a mouse, and/or any other suitable input device. Output module 608 may send output to an actuator, indicator, motor controller, printer, machine, display, and/or any other suitable output device.

### H. Illustrative Distributed Data Processing System

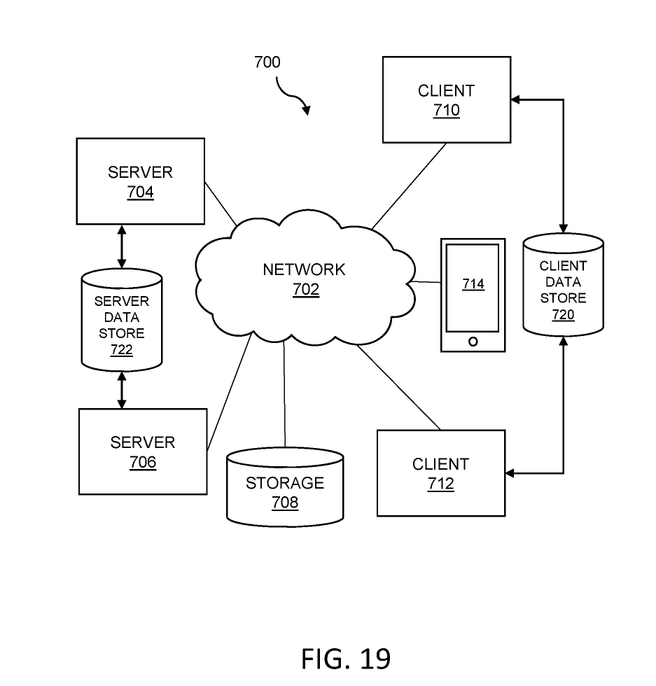

As shown in FIG. 19, this example describes a general network data processing system 700, interchangeably termed a computer network, a network system, a distributed data processing system, or a distributed network, aspects of which may be included in one or more illustrative embodiments of the vertical plant growing systems and methods described herein. For example, control system 400 may be implemented as or as part of a computer network, such that controls may be executed remotely and/or using more than one data processing device. In some embodiments, data regarding the operation of the system may be stored on a network resource. In some embodiments, smart devices, such as a tablet or smart phone, may be utilized to access and interface with control system 400 remotely or over a wireless network.

It should be appreciated that FIG. 19 is provided as an illustration of one implementation and is not intended to imply any limitation with regard to environments in which different embodiments may be implemented. Many modifications to the depicted environment may be made.

Network system 700 is a network of devices (e.g., computers), each of which may be an example of data processing system 500, and other components. Network data processing system 700 may include network 702, which is a medium configured to provide communications links between various devices and computers connected within network data processing system 700. Network 702 may include connections such as wired or wireless communication links, fiber optic cables, and/or any other suitable medium for transmitting and/or communicating data between network devices, or any combination thereof.

In the depicted example, a first network device 704 and a second network device 706 connect to network 702, as do one or more computer-readable memories or storage devices 708. Network devices 704 and 706 are each examples of data processing system 500, described above. In the depicted example, devices 704 and 706 are shown as server computers, which are in communication with one or more server data store(s) 722 that may be employed to store information local to server computers 704 and 706, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 710 and 712 and/or a client smart device 714, may connect to network 702. Each of these devices is an example of data processing system 500, described above regarding FIG. 17. Client electronic devices 710, 712, and 714 may include, for example, one or more personal computers, network computers, and/or mobile computing devices such as personal digital assistants (PDAs), smart phones, handheld gaming devices, wearable devices, and/or tablet computers, and the like. In the depicted example, server 704 provides information, such as boot files, operating system images, and applications to one or more of client electronic devices 710, 712, and 714. Client electronic devices 710, 712, and 714 may be referred to as “clients” in the context of their relationship to a server such as server computer 704. Client devices may be in communication with one or more client data store(s) 720, which may be employed to store information local to the clients (e.g., cookie(s) and/or associated contextual information). Network data processing system 700 may include more or fewer servers and/or clients (or no servers or clients), as well as other devices not shown.

In some examples, first client electric device 710 may transfer an encoded file to server 704. Server 704 can store the file, decode the file, and/or transmit the file to second client electric device 712. In some examples, first client electric device 710 may transfer an uncompressed file to server 704 and server 704 may compress the file. In some examples, server 704 may encode text, audio, and/or video information, and transmit the information via network 702 to one or more clients.

Client smart device 714 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 700 may be stored in or on a computer-readable storage medium, such as network-connected storage device 708 and/or a persistent storage 508 of one of the network computers, as described above, and may be downloaded to a data processing system or other device for use. For example, program code may be stored on a computer-readable storage medium on server computer 704 and downloaded to client 710 over network 702, for use on client 710. In some examples, client data store 720 and server data store 722 reside on one or more storage devices 708 and/or 508.

Network data processing system 700 may be implemented as one or more of different types of networks. For example, system 700 may include an intranet, a local area network (LAN), a wide area network (WAN), or a personal area network (PAN). In some examples, network data processing system 700 includes the Internet, with network 702 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 702 may be referred to as a “cloud.” In those examples, each server 704 may be referred to as a cloud computing node, and client electronic devices may be referred to as cloud consumers, or the like. FIG. 19 is intended as an example, and not as an architectural limitation for any illustrative embodiments.

### I. Illustrative Combinations and Additional Examples

This section describes additional aspects and features of a vertical plant growing system, presented without limitation as a series of paragraphs, some or all of which may be alphanumerically designated for clarity and efficiency. Each of these paragraphs can be combined with one or more other paragraphs, and/or with disclosure from elsewhere in this application, including those listed in the Cross-References section, in any suitable manner. Some of the paragraphs below may expressly refer to and further limit other paragraphs, providing without limitation examples of some of the suitable combinations.

A0. A tower for growing plants in a vertical arrangement, the tower comprising:

a generally cylindrical plant stand including a plurality of hollow support legs joined to each other by a first air duct, and at least one substantially vertical wall having a plurality of shelves disposed between a pair of the hollow support legs, wherein each of the shelves is configured to support at least one plant, and the plant stand defines an inner volume;

a lighting column disposed within the inner volume of the plant stand, the lighting column including at least one lighting element housed in a hollow tube and configured to provide light to plants disposed on the plurality of shelves, the hollow tube defining a continuous air pathway from an intake portion at a lower end of the lighting column and around the at least one lighting element to an upper outlet of the lighting column;

wherein each of the hollow legs includes a plurality of apertures on an inner face, the plurality of apertures configured to guide air from the first air duct into the inner volume of the plant stand.

A1. The tower of A0, wherein the first air duct comprises a partial ring, such that the first air duct has two ends and an air inlet disposed between the two ends.

A2. The tower of any of paragraphs A0 through A1, wherein the first air duct is disposed at upper ends of the plurality of hollow support legs.

A3. The tower of any of paragraphs A0 through A2, wherein the plant stand forms a polygonal cylinder.

A4. The tower of A3, wherein the plant stand has eight sides.

A5. The tower of A3, wherein each side of the polygonal cylinder is defined by one or more of the plurality of shelves.

A6. The tower of any of paragraphs A0 through A5, wherein the plant stand includes a repositionable portion of the wall configured to provide user access to the inner volume.

A7. The tower of any of paragraphs A0 through A6, wherein the plants comprise flowering plants.

B0. A system for growing plants, the system comprising:

a heating, ventilation, and air conditioning (HVAC) system including a first plenum in communication with a cooler and an outdoor air supply, and a second plenum coupled to the first plenum by a first air pathway;

a generally cylindrical, vertical plant-growing tower in communication with the HVAC system, such that an interior volume of the tower is coupled to one or more second air pathways configured to supply air from the first plenum to the tower, to a third air pathway configured to supply air from the second plenum, and to a fourth air pathway configured to transport air to the second plenum, wherein the third and fourth pathways are independent of each other;

the plant-growing tower having a plurality of substantially horizontal shelves configured to support a plurality of plants in a vertical arrangement, and a vertical lighting array disposed within the interior volume and adjacent the plurality of shelves;

wherein the HVAC system includes a plurality of airflow control devices, at least a respective one of the airflow control devices disposed in each of the first, second, third, and fourth air pathways; and

wherein the plurality of airflow control devices are transitionable between a first mode, in which air is caused to flow in a first loop comprising the first air pathway, the first plenum, one of the second air pathways, the plant-growing tower, the fourth air pathway, and the second plenum, and a second mode, in which air is circulated in a second loop comprising the third air pathway, the plant-growing tower, the fourth air pathway, and the second plenum.

B1. The system of B0, wherein the plant-growing tower includes an outer plant stand portion defining the interior volume and laterally surrounding a central column portion.

B2. The system of B1, the outer plant stand portion having a main air supply ring coupled to a plurality of hollow support legs, a plurality of plant shelves coupled to the support legs and forming substantially vertical walls of the outer plant stand.

B3. The system of B2, wherein each of the support legs includes a plurality of apertures on an inner face configured to provide air from the main air supply ring to the interior volume.

B4. The system of B2, wherein the main air supply ring is coupled to an air duct of the one or more second air pathways of the HVAC system.

B5. The system of B1, wherein a hollow enclosure surrounding the vertical lighting array is coupled to the fourth air pathway.

C0. A method for growing plants, the method comprising:

the first mode described above (normal—lights on); and

the second mode described above (internal cycle—lights off).

C1. The method of C0, further including the third mode described above (heat burst).

C2. The method of C0, further including a sub-mode of the second mode wherein temperature of the airflow is reduced to near freezing.

D0. A plant growing methodology comprising fans, coolers, dehumidifiers, plenums, controls, dampers, exhausts, supply air (diffusers/ports), sensors, accessible vertical/tiered plant stand surrounding vertical lighting column. In some examples, the cooler unit is located within the cool air control room (different from the warm/hot air control room) and runs when the lights are off (plant night cycle). The day cycle (lights on) runs at night pulling in and utilizing the naturally cooler air. During the plant night cycle (lights off) a recirculating air system runs an “internal cycle mode”. No air from outside is introduced and a constant loop with the air control room and back to grow systems. A dehumidifier may be employed, e.g., to keep moisture levels below 45%.

D1. The method of D0, further comprising: To combat excess heat from high-pressure sodium lights, air is pulled through the vertical light column from an intake point at the bottom of the tower. This air is reclaimed in the hot air plenum, for use of redistribution (internal cycle supply located at top of octagon) when temperatures are too low.

D2. The method of D1, further comprising: The recirculated/captured hot air is then controlled in one of three ways: the reclaimed heated air is either exhausted (D3), redirected to the main plenum (D4), or sent back to the tower to kill mold (AKA heat burst) (D5).

D3. The method of D2, further comprising: When heat is not needed to resupply back to the plant towers, the hot air is directed to the hot air plenum and then exhausted to the outside.

D4. The method of D2, further comprising: When heat is needed (lower temperatures at the air control room), the reclaimed hot air is directed to the hot air plenum and then directed to the main plenum where it is resupplied back to the towers.

D5. The method of D2, further comprising: Reclaimed hot air from light column(s) is directed to the hot air plenum; from this point the hot air is redirected into the air control room to mix with incoming ambient air. This prevents the drastic slow down of incoming air when it is cold outside. Keeping air speeds up during colder temperatures may be helpful to prevent CO₂ level drops and humidity buildup. Lights (day cycle) may be run at night to guarantee the temperature outside can be adjusted at high speeds with heat.

E0. Air may be redirected directly from our hot air control room to the tower to be blasted downward through the plants, e.g., to kill powdery mildew. It is exhausted at the same rate from the bottom of the tower, helping pull the warm air downward. Powdery mildew lives on the top of the plant's leaves and dies at temperatures above 92 degrees F. In some examples, the tower is pushed up to 96 degrees F. for five minutes, exchanging the air every thirty seconds constantly during this heat burst.

F0. In some examples, exhaust speed in the tower peaks at a full air replacement rate of once every ten seconds. This may be achieved with a sensor in the tower that senses day/night and adjusts the temperature accordingly by kicking on the main supply to the legs of the tower and an equal sized exhaust fan connected at the top opening on the tower.

G0. In some examples, the system operates from approximately 35 F to approximately 98 F.

H0. In some examples, on an as needed basis, when bugs/insects are present, the temperature may be set to 35° F. for a period of time determined by the operator.

I0. In some examples, air moving rapidly around the plants at controlled temperatures solves many bug and mold issues. The system has the ability to vary the temperature of the air over a 24-hour cycle to prevent both mold and insects. For example, the flowing air may be heated to over 92 F once a day for a few minutes, and the night cycle may be much colder than normal.

J0. A plant growing method comprising:

supporting one or more plants on an indoor plant growing tower including an outer generally-cylindrical plant stand defining an interior volume, a vertical lighting tube containing one or more grow lights being disposed within the interior volume, such that a majority of leaves of the one or more plants are disposed within the interior volume;

transitioning the plant growing tower between a first mode and a second mode;

wherein the first mode includes supplying air at a first temperature into the interior volume and exhausting at least a portion of the air out of the interior volume through the light tube when the one or more grow lights are turned on, such that the air is circulated through the one or more plants and over the one or more grow lights, wherein the first temperature is configured to encourage growth of the one or more plants;

wherein the second mode includes supplying air at a second temperature into the interior volume and exhausting at least a portion of the air out of the interior volume when the one or more grow lights are turned off, such that the air is circulated through the one or more plants, wherein the second temperature is lower than the first temperature and is configured to encourage dormancy of the one or more plants; and

temporarily transitioning the plant growing tower to a third mode, the third mode including supplying air at a third temperature into the interior volume and exhausting at least a portion of the air out of the interior volume through the light tube when the one or more grow lights are turned on, such that the air is circulated through the one or more plants and over the one or more grow lights, wherein the third temperature is higher than the first temperature and is configured to inhibit growth of one or more types of fungus.

J1. The method of J0, wherein the first temperature is approximately 65 to approximately 74 degrees Fahrenheit (F).

J2. The method of any of paragraphs J0 through J1, wherein the second temperature is approximately 45 F.

J3. The method of any of paragraphs J0 through J2, wherein the third temperature is approximately 92 F to approximately 98 F.

J4. The method of any of paragraphs J0 through J3, further comprising:

temporarily transitioning the plant growing tower to a fourth mode, the fourth mode including supplying air at a fourth temperature into the interior volume and exhausting at least a portion of the air out of the interior volume when the one or more grow lights are turned off, such that the air is circulated through the one or more plants, wherein the fourth temperature is lower than the second temperature and is configured to inhibit growth of one or more types of insect.

J5. The method of J4, wherein the fourth temperature is approximately 35 F.

J6. The method of J4, including maintaining the plant growing tower in the fourth mode for approximately four hours.

J7. The method of any of paragraphs J0 through J6, including maintaining the plant growing tower in the third mode for approximately five minutes after reaching the third temperature.

J8. The method of any of paragraphs J0 through J7, wherein transitioning the plant growing tower between the first mode and the second mode is performed every approximately twelve hours.

J9. The method of any of paragraphs J0 through J8, wherein transitioning from the second mode to the first mode further comprises temporarily heating the air supplied to the interior volume using a furnace.

J10. The method of any of paragraphs J0 through J9, wherein the first mode further comprises cooling the exhausted air using a cooler and returning the cooled air to the interior volume.

J11. The method of any of paragraphs J0 through J10, further comprising automatically transitioning between the first, second, and third modes using a controller.

J12. The method of any of paragraphs J0 through J11, wherein air is supplied and exhausted using a forced-air system.

J13. The method of J12, wherein air is forcibly supplied to the interior volume using a first fan and forcibly exhausted from the interior volume using a second fan.

J14. The method of J13, wherein the first fan and the second fan comprise inline centrifugal fans.

J15. The method of any of paragraphs J0 through J14, wherein the first mode further comprises heating the exhaust air using the one or more grow lights.

J16. The method of any of paragraphs J0 through J15, further comprising controlling a flow rate of the air through the interior volume in each mode at a minimum of approximately 800 cubic feet per minute (cfm).

J17. The method of J16, further comprising controlling the flow rate of the air through the interior volume in the first mode at approximately 800 cfm to approximately 2000 cfm.

K0. A method for growing plants indoors with a reduced or eliminated need for herbicides and pesticides, the method comprising:

supporting a plurality of plants on a vertical plant stand surrounding a central grow light column; and

using a forced-air system in communication with the plant stand, circulating air through the plants on the plant stand by transitioning between at least three modes at selected airflow rates and selected temperatures:

wherein a plant day mode includes energizing the grow light column and circulating the air at approximately 65 F to approximately 74 F to simulate daytime conditions;

wherein a plant night mode includes deenergizing the grow light column and circulating the air at approximately 45 F to simulate nighttime conditions; and

wherein a heat burst mode includes energizing the grow light column and heating the air to above approximately 92 F to kill existing fungus.

K1. The method of K0, wherein the at least three modes further comprise a cold burst mode including deenergizing the grow light column and cooling the air to approximately 35 F to inhibit insects.

K2. The method of any of paragraphs K0 through K1, further comprising automatically transitioning between the plant day mode and the plant night mode every approximately twelve hours.

K3. The method of any of paragraphs K0 through K2, wherein the heat burst mode has a duration of approximately five minutes after temperature reaches 92 F.

K4. The method of any of paragraphs K0 through K3, wherein circulating the air through the plants includes forcing air from the forced-air system through one or more hollow legs of the plant stand and onto the plants via a plurality of apertures in each of the one or more hollow legs.

K5. The method of any of paragraphs K0 through K4, wherein the grow light column comprises a hollow tube surrounding one or more lighting elements, and each mode further comprises exhausting air from the plant stand through the hollow tube.

K6. The method of any of paragraphs K0 through K5, wherein the selected airflow rates range from approximately 800 cubic feet per minute to approximately 2000 cubic feet per minute.

L0. An indoor plant growing system comprising:

a vertical plant tower including an outer plant stand surrounding a central lighting column;

a heating, ventilation, and air conditioning (HVAC) system in communication with the vertical plant tower via one or more airflow control devices;

a plurality of environmental sensors disposed in the HVAC system and in the vertical plant tower; and

a controller configured to monitor the plurality of environmental sensors and to control the one or more airflow devices, the controller including at least one processor in communication with at least one memory, wherein a plurality of instructions are stored in the at least one memory and executable by the at least one processor to:
operate the HVAC system and vertical plant tower in a first mode, in which the central lighting column is energized and air is circulated by the HVAC system through the vertical plant tower at approximately 65 F to approximately 74 F to simulate daytime conditions;
operate the HVAC system and vertical plant tower in a second mode, in which the central lighting column is deenergized and air is circulated through the vertical plant tower by the HVAC system at approximately 45 F or below to simulate nighttime conditions;
operate the HVAC system and vertical plant tower in a third mode, in which the central lighting column is energized and air is circulated through the vertical plant tower by the HVAC system at approximately 92 F or above; and automatically transition between the first, second, and third modes based on duration of each mode and feedback from the sensors.

L1. The method of L0, wherein the second mode includes cooling the air to approximately 35 F.

L2. The method of any of paragraphs L0 through L1, wherein automatically transitioning between the first, second, and third modes includes transitioning between the first mode and the second mode every approximately twelve hours.

L3. The method of any of paragraphs L0 through L2, wherein the third mode is controlled by the controller to have a duration of approximately five minutes after temperature reaches 92 F.

L4. The method of any of paragraphs L0 through L3, wherein air is circulated through the vertical plant tower by the HVAC system by forcing air through one or more hollow legs of the plant stand and onto plants supported thereon via a plurality of apertures in each of the one or more hollow legs.

L5. The method of any of paragraphs L0 through L4, wherein the central lighting column comprises a hollow tube surrounding one or more lighting elements, and each mode further comprises exhausting air from the vertical plant tower through the hollow tube.

L6. The method of any of paragraphs L0 through L5, wherein the controller further controls airflow rates through the vertical plant tower from approximately 800 cubic feet per minute to approximately 2000 cubic feet per minute.

### Advantages, Features, and Benefits

The different embodiments and examples of the plant growing systems and methods described herein provide several advantages over known solutions. For example, illustrative embodiments and examples described herein regulate temperature and air speed within vertical plant stand to promote optimal growing conditions with minimal power consumption and exclusion of CO₂, chemicals or pesticides to combat mold and insects

Additionally, and among other benefits, illustrative embodiments and examples described herein provide improved energy conservation. Specifically, power consumption is reduced (relative to industry standards) for heating and cooling, in part because the systems utilize optimal outside ambient air conditions to coordinate plant cycles. For example, plant night cycle (lights off) is performed during the higher temperature daytime hours, and plant day cycle (lights on) is typically performed during cooler nighttime hours.

Additionally, and among other benefits, illustrative embodiments and examples described herein inhibit insect and other bug reproduction using air coolers in lieu of standard air conditioners to promote colder temperatures (around 40 F) at a reduced power consumption.

Additionally, and among other benefits, illustrative embodiments and examples described herein allow warm air from around the hot grow lights to be reclaimed and used by the system (e.g., for a heat burst).

Additionally, and among other benefits, illustrative embodiments and examples described herein facilitate an organic growing technique: insects are ectothermic organisms that can be controlled by simulating dramatic night temperature drops by way of internal looping where cooled air is exchanged with the vertical plant stand during plant night cycle, and temperatures are maintained at levels that prevent insect growth. (CO₂ replenishment is not required for growth during the plant night cycle.)

Additionally, and among other benefits, illustrative embodiments and examples described herein facilitate mold control by conditioning supply air with dehumidifiers and bursts of hot air.

Additionally, and among other benefits, illustrative embodiments and examples described herein maximize efficiency and production per square foot of floor space. In one example, 112 plants are grown in an area that would normally allow only twelve of the same plants if conventional overhead lighting were used.

Additionally, and among other benefits, illustrative embodiments and examples described herein provide a solution to the fact that heat generates quickly in the air space outside of light columns (between light column and plants), thereby promoting insects and heat damage to the top of the plant columns. Specifically, this problem is mitigated by pulling air through the light column, providing approximately two-thirds of the tower's exhaust at the top of the column with air speeds up to roughly ten times speeds previously known in the industry. Additionally, this heat is reclaimed and used to condition the supply air.

Additionally, and among other benefits, illustrative embodiments and examples described herein provide an improved solution to the known situation where lighting is provided by hanging eight-inch cooling tubes from chains on the inside of a cylindrical plant tower. The towers described herein are self-supporting and lighting elements are housed in cooling tubes that can be removed/replaced for maintenance, even in mid-cycle. In some embodiments, the central light column has holes on the bottom that draw air evenly from the octagon prior to being filtered to keep light tube clean. It may be designed with 10-inch diameter glass housing to prevent restriction caused by the bulb/element on the 8-inch inline exhaust duct and fan.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. An indoor plant growing system comprising:
a vertical plant tower including an outer plant stand surrounding a central lighting column;
a heating, ventilation, and air conditioning (HVAC) system in communication with the vertical plant tower via one or more airflow control devices;
a plurality of environmental sensors disposed in the HVAC system and in the vertical plant tower; and
a controller configured to monitor the plurality of environmental sensors and to control the one or more airflow devices, the controller including at least one processor in communication with at least one memory, wherein a plurality of instructions are stored in the at least one memory and executable by the at least one processor to:
operate the HVAC system and vertical plant tower in a first mode, in which the central lighting column is energized and air is circulated by the HVAC system through the vertical plant tower at approximately 65 F to approximately 74 F to simulate daytime conditions;
operate the HVAC system and vertical plant tower in a second mode, in which the central lighting column is deenergized and air is circulated through the vertical plant tower by the HVAC system at approximately 45 F or below to simulate nighttime conditions;
operate the HVAC system and vertical plant tower in a third mode, in which the central lighting column is energized and air is circulated through the vertical plant tower by the HVAC system at approximately 92 F or above; and
automatically transition between the first, second, and third modes based on duration of each mode and feedback from the environmental sensors.

2. The method of claim 1, wherein the second mode includes cooling the air to approximately 35 F.

3. The method of claim 1, wherein automatically transitioning between the first, second, and third modes includes transitioning between the first mode and the second mode every approximately twelve hours.

4. The method of claim 1, wherein the third mode is controlled by the controller to have a duration of approximately five minutes after temperature reaches 92 F.

5. The method of claim 1, wherein air is circulated through the vertical plant tower by the HVAC system by forcing air through one or more hollow legs of the plant stand and onto plants supported thereon via a plurality of apertures in each of the one or more hollow legs.

6. The method of claim 1, wherein the central lighting column comprises a hollow tube surrounding one or more lighting elements, and each mode further comprises exhausting air from the vertical plant tower through the hollow tube.

7. A method for growing plants indoors with a reduced or eliminated need for herbicides and pesticides, the method comprising:
supporting a plurality of plants on a vertical plant stand surrounding a central grow light column; and
using a forced-air system in communication with the plant stand, circulating air through the plants on the plant stand by transitioning between at least three modes at selected airflow rates and selected temperatures:
wherein a plant day mode includes energizing the grow light column and circulating the air at approximately 65 F to approximately 74 F to simulate daytime conditions;
wherein a plant night mode includes deenergizing the grow light column and circulating the air at approximately 45 F to simulate nighttime conditions; and
wherein a heat burst mode includes energizing the grow light column and heating the air to above approximately 92 F to kill existing fungus.

8. The method of claim 7, wherein the at least three modes further comprise a cold burst mode including deenergizing the grow light column and cooling the air to approximately 35 F to inhibit insects.

9. The method of claim 7, further comprising automatically transitioning between the plant day mode and the plant night mode every approximately twelve hours.

10. The method of claim 7, wherein the heat burst mode has a duration of approximately five minutes after temperature reaches 92 F.

11. The method of claim 7, wherein circulating the air through the plants includes forcing air from the forced-air system through one or more hollow legs of the plant stand and onto the plants via a plurality of apertures in each of the one or more hollow legs.

12. The method of claim 7, wherein the grow light column comprises a hollow tube surrounding one or more lighting elements, and each mode further comprises exhausting air from the plant stand through the hollow tube.

13. A plant growing method comprising:
supporting one or more plants on an indoor plant growing tower including an outer generally-cylindrical plant stand defining an interior volume, a vertical lighting tube containing one or more grow lights being disposed within the interior volume, such that a majority of leaves of the one or more plants are disposed within the interior volume;
transitioning the plant growing tower between a first mode and a second mode;
wherein the first mode includes supplying air at a first temperature into the interior volume and exhausting at least a portion of the air out of the interior volume through the vertical lighting tube when the one or more grow lights are turned on, such that the air is circulated through the one or more plants and over the one or more grow lights, wherein the first temperature is configured to encourage growth of the one or more plants;
wherein the second mode includes supplying air at a second temperature into the interior volume and exhausting at least a portion of the air out of the interior volume when the one or more grow lights are turned off, such that the air is circulated through the one or more plants, wherein the second temperature is lower than the first temperature and is configured to encourage dormancy of the one or more plants; and
temporarily transitioning the plant growing tower to a third mode, the third mode including supplying air at a third temperature into the interior volume and exhausting at least a portion of the air out of the interior volume through the light tube when the one or more grow lights are turned on, such that the air is circulated through the one or more plants and over the one or more grow lights, wherein the third temperature is higher than the first temperature and is configured to inhibit growth of one or more types of fungus.

14. The method of claim 13, wherein the first temperature is approximately 70 to approximately 74 degrees Fahrenheit (F).

15. The method of claim 13, wherein the second temperature is approximately 45 F.

16. The method of claim 13, wherein the third temperature is approximately 92 F to approximately 98 F.

17. The method of claim 13, further comprising:
inhibiting growth of one or more type of insect by temporarily transitioning the plant growing tower to a fourth mode, the fourth mode including supplying air at approximately 35 F into the interior volume and exhausting at least a portion of the air out of the interior volume when the one or more grow lights are turned off, such that the air is circulated through the one or more plants.

18. The method of claim 17, including maintaining the plant growing tower in the fourth mode for approximately four hours.

19. The method of claim 13, including maintaining the plant growing tower in the third mode for approximately five minutes after reaching the third temperature.

20. The method of claim 13, wherein transitioning the plant growing tower between the first mode and the second mode is performed every approximately twelve hours.

21. The method of claim 13, wherein transitioning from the second mode to the first mode further comprises temporarily heating the air supplied to the interior volume using a furnace.

22. The method of claim 13, wherein the first mode further comprises cooling the exhausted air using a cooler and returning the cooled air to the interior volume.

23. The method of claim 13, wherein air is supplied and exhausted using a forced-air system.

24. The method of claim 23, wherein air is forcibly supplied to the interior volume using a first fan and forcibly exhausted from the interior volume using a second fan.

25. The method of claim 13, further comprising controlling a flow rate of the air through the interior volume in each mode at a minimum of approximately 800 cubic feet per minute (cfm).
